(19) United States
(12) Patent Application Publication
(10) Pub. No.: US 2020/0113336 A1
(43) Pub. Date: Apr. 16, 2020

(54) Inclination-Adjustable Armrest

(71) Applicant: Rollax GmbH & Co. KG, Bad Salzuflen (DE)

(72) Inventors: Dmitry Friesen, Porta Westfalica (DE); Michael Kuhlmann, Bielefeld (DE)

(21) Appl. No.: 16/554,830

(22) Filed: Aug. 29, 2019

(30) Foreign Application Priority Data
Oct. 15, 2018 (DE) 202018105885.1

(51) Int. Cl. A47C 7/54; B60N 2/75; F16C 11/10; A47C 7/50; B60N 3/06

(52) U.S. Cl. CPC A47C 7/541; B60N 2/767; B60N 3/063; A47C 7/5066; F16C 11/103

(57) ABSTRACT

An inclination-adjustable armrest (10) includes a pivot bearing (12) formed at one end of the armrest, the pivot bearing defining a pivotal axis (A) for the armrest, a clamping-type locking mechanism (16) arranged on the pivotal axis and being adapted to be unlocked by a release member (20) that is rotatable about the pivotal axis, and an actuating mechanism for actuating the release member, wherein the actuating mechanism has a release lever (22) that is connected to the release member (20) and is rotatable about the pivotal axis (A) and which extends through the interior of the armrest (10) to the end of the armrest opposite to the pivot bearing (12) and exits the armrest at that opposite end.

The invention relates to an inclination-adjustable armrest comprising a pivot bearing formed at one end of the armrest, the pivot bearing defining a pivotal axis for the armrest, the armrest further comprising a clamping-type locking mechanism arranged on the pivotal axis and being adapted to be unlocked by means of a release member that is rotatable about the pivotal axis, and an actuating mechanism for actuating the release member.

More particularly, the invention relates to an armrest for a vehicle seat.

For armrests of vehicle seats, arresting mechanisms have been known which have a claw-type locking mechanism permitting to lock the armrest in angular positions that are adjustable in discrete steps.

US 2014/159461 A1 discloses an armrest of the type mentioned above, in which the inclination can be adjusted continuously. The actuating mechanism has a push rod which extends through the interior of the armrest.

It is an object of the invention to provide an armrest which can be adjusted continuously by means of an ergonomic actuating mechanism.

According to the invention, in order to achieve this object, the actuating mechanism has a release lever that is connected to the release member and is rotatable about the pivotal axis and which extends through the interior of the armrest to the end of the armrest opposite to the pivot bearing and exits the armrest at that opposite end.

In order to unlock the clamping-type locking mechanism, the release member needs to be rotated only by a very small angle. Consequently, although the release lever has a considerable length, it can be accommodated in the armrest with sufficient play for being tilted to such an extent that the release member is actuated and the locking mechanism is unlocked. It is a particular advantage that the release lever is pivoted about the same axis as the armrest as a whole. Unlocking the locking mechanism and then tilting the armrest into the desired new position can therefore be achieved in a single, smooth train of motion.

Useful details and further developments of the invention are indicated in the dependent claims.

The clamping-type locking mechanism can be formed by a known clamp roll freewheel assembly of a type similar to those used also for adjusting a seat height or an inclination of the seatback of a vehicle seat. The clamp roll freewheel assembly may have a symmetric design such that the armrest can be adjusted continuously in both directions. The release member causes the locking mechanism to be unlocked as soon as it is rotated out of a neutral position in any direction.

However, an embodiment with a unidirectional clamp roll freewheel mechanism is also possible. In that case, the pivotal movement of the armrest is blocked only in one of the two pivotal directions.

The invention also relates to an inclination-adjustable footrest which has an arresting and release mechanism based on the same function principle.

Embodiment examples will now be described in conjunction with the drawings, wherein:

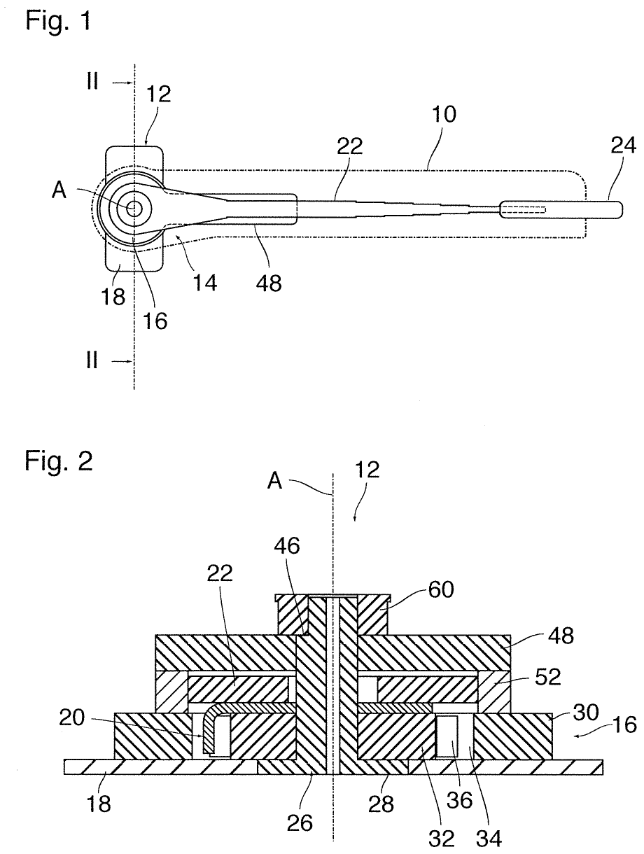

FIG. 1 is a view of an arresting mechanism in an inclination-adjustable armrest;

FIG. 2 is an enlarged section taken along the line II-II in FIG. 1;

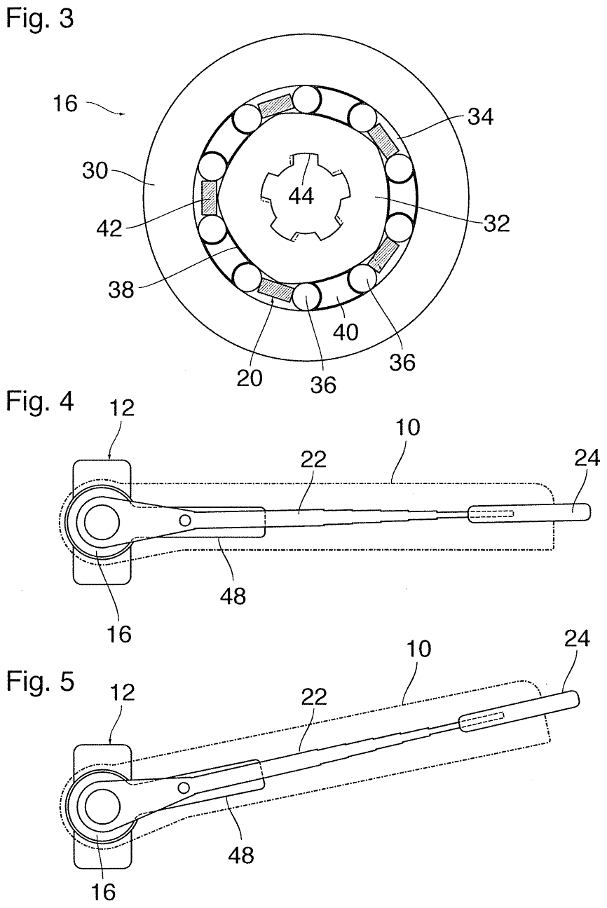

FIG. 3 is a view of a clamping type locking mechanism in the arresting mechanism shown in FIGS. 1 and 2;

FIGS. 4 and 5 show the arresting mechanism according to FIG. 1 in different states;

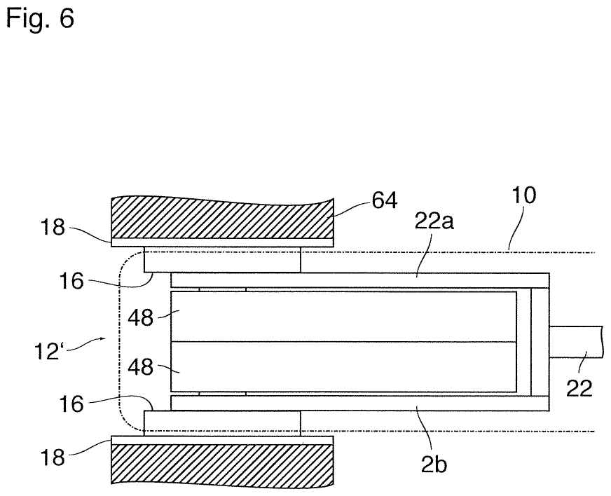

FIG. 6 shows an armrest and an arresting mechanism according to another embodiment;

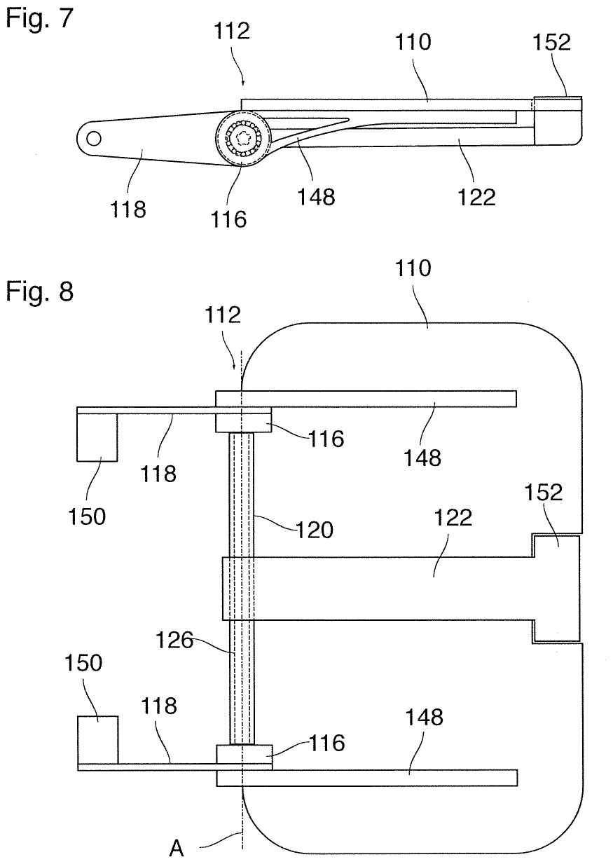

FIG. 7 is a side view of an inclination-adjustable footrest; and

FIG. 8 shows the footrest according to FIG. 7 in a bottom view.

In FIG. 1, the contour of an inclination-adjustable armrest 10 for a vehicle seat has been shown in phantom lines. At one end, on the left side in FIG. 1, the armrest has a pivot bearing 12 with which it is pivotally mounted on a vehicle seat, e.g. on the seat back. The pivot bearing 12 has an integrated arresting mechanism 14 which serves for arresting the armrest 10 in any desired inclination. To that end, the arresting mechanism 14 has a clamping-type locking mechanism 16 that is mounted on a mounting plate 18 coaxially with a pivotal axis A that is defined by the pivot bearing 12.

A release member (FIG. 2), which is not visible in FIG. 1, is rotatable about the pivotal axis A within a limited angular range and is rigidly connected to a release lever 22 that extends through the interior of the armrest 10 and exits the armrest with an actuating knob 24 at the end of the armrest that is opposite to the pivot bearing 12.

The design of the pivot bearing 12 has been shown in an axial section in FIG. 2. A shaft 26, the longitudinal axis of which defines the pivotal axis A, has a head 28 with which it is rotatably supported in a recess of the mounting plate 18. The clamping-type locking mechanism 16 has an outer ring 30 that is rigidly held on the mounting plate 18, and an inner ring 32 that is keyed onto the shaft 26 and forms an annular gap 34 with the outer ring 30. The angular gap 34 accommodates a set of clamp rollers 36.

As has been shown more clearly in FIG. 3, the internal peripheral surface of the outer ring 30 forms a cylindrical race for the clamp rollers 36. In contrast, the outer peripheral surface of the inner ring 32 forms a non-circular clamping contour 38, so that the annular gap 34 flares-out and tapers alternatingly in circumferential direction. The clamp rollers 36 are arranged in pairs, and an elastic spreading member 40 is arranged in the annular gap between each pair of clamp rollers 36 for urging the two clamp rollers apart. Each of the two clamp rollers 36 is thereby urged into a direction in which the annular gap 34 tapers, so that the clamp roller is clamped. If the inner ring 32 is subject to a torque that has the tendency to rotate the inner ring in any direction, this reduces the clamp action for one clamp roller 36 of each pair whereas it increases the clamp action for the other clamp roller of this pair, so that the locking mechanism is blocked in each direction. In this way, the angular position of the inner ring 32 may be adjusted continuously and locked in any angular position.

Of the release member 20 that was mentioned above, FIG. 3 shows only separate claws 42 which project axially into the annular gap 34 and are arranged between the individual pairs of clamp rollers. The release member 20 is rotatable relative to the inner ring 32 with limited play. If the release member 20 is subject to a torque that acts clock-wise in FIG. 1, for example, the clamp roller 36 that precedes the respective claw 42 is pressed against the associated spreading member 40 and is thereby held in a portion of the annular gap 34 in which this annular gap has a larger width, so that the clamp action is cancelled. Then, when the release member 20 is rotated further and the inner ring 32 is entrained in clock-sense, the clamp action is cancelled also for the other clamp roller of each pair, so that the release member 20 and the inner ring 32 can now be rotated jointly relative to the outer ring 30. The same holds true also for a rotary movement in counter-clock sense.

As can further be seen in FIG. 3, the internal contour of the inner ring 32 forms key groves 44 which are in engagement with keys 46 of the shaft 26 shown in FIG. 2. Thus, when the locking mechanism 16 blocks the rotation of the inner ring 32, the shaft 26 is also locked against rotation.

FIGS. 1 and 2 further show an armrest carrier 48 which is also keyed non-rotatably on the shaft 26. Thus, the entire armrest 10 is also arrested by the locking mechanism 16 via the armrest carrier 48.

As has been shown in FIG. 2, the release lever 22 is arranged between the armrest carrier 48 and the release member 20 and is rigidly connected to the release member. The release lever 22 is not in engagement with the keys 46 of the shaft 26 and is rotatable about the pivotal axis A together with the release member 20. The angular range of this rotary movement is limited in the example shown by the fact that the release member 20 has key grooves which have been shown in phantom lines in FIG. 3 and which have a somewhat larger width than the keys 46 of the shaft 26.

The armrest carrier 48 is supported on the outer ring 30 of the locking mechanism via a slide ring 52.

Arranged on the free end of the shaft 26 is a spacer ring 60 (FIG. 2) by which the pivot bearing 12 is adapted to the width of the armrest 10 and which forms another rotary bearing for the shaft 26.

If, now, the armrest 10 shall be adjusted in its inclination, upwards in counter-clock sense in FIG. 4, for example, then the user pulls the actuating knob 24 of the release lever 22 upwards with her fingers. The release lever 22 is thereby pivoted relative to the cantilevered part of the armrest carrier 48 and entrains also the release member 20 in this pivotal movement, so that the locking mechanism 16 is unlocked. When the user pulls the actuating knob 24 further upwards, the armrest carrier 48 is also driven in the rotary direction, due to the limited play, and the armrest 10 as a whole is tilted upwards, as has been shown in FIG. 5. As soon as the user releases the actuating knob 24, the spreading members 40 (FIG. 2) urge the release member and also the release lever 22 back into its initial position relative to the armrest carrier 48, and the armrest is locked by the clamping type locking mechanism 16 in the angular position that it has reached.

In the same way, the inclination of the armrest 10 can also be adjusted in the opposite direction, i.e. in clock-sense in FIG. 4. In this case, the locking mechanism 16 is unlocked by pressing the actuating knob 24 of the release lever 22 downwards.

In another embodiment, a dedicated return spring may be provided for returning the release lever 22 into the initial position.

In another embodiment, the release member 20 and the release lever 22 may be arranged on axially opposite sides of the armrest carrier 48 and may be connected by lugs that penetrate the armrest carrier with play.

It will be understood that interior of the armrest 10 must be designed such that it allows for the limited pivotal movement of the release lever 22 relative to the armrest carrier 48. This can be achieved, for example, by providing an appropriate free space in the interior of the armrest 10 or, optionally, simply by a design in which the cushioning of the armrest yields and thereby permits the pivotal movement of the release lever.

As a further embodiment, FIG. 6 shows an armrest that is pivotably supported in a center console 64 of an automotive vehicle by means of a pivot bearing 12′. The pivot bearing has a mirror-symmetric arrangement of two mounting plates 18, two clamping type locking mechanisms 16 and two armrest carriers 48 arranged back-to-back. The release lever 22 is branched into two arms 22a and 22b each of which is arranged between one of the armrest carriers 48 and the associated locking mechanism 16 and is directly connected to the release member of that locking mechanism. The keys 46, which are not visible in FIG. 6, pass through the arms 22a, 22b with sufficient play, so that the release lever can be pivoted to a sufficient amount.

The function principle of the arresting mechanism that has been described above can be employed not only for adjustable armrests but can be employed analogously also for inclination-adjustable footrests. An example of such a footrest has been shown in FIGS. 7 and 8. Details that correspond, as far as their function is concerned, to the details that have been described above for the armrest are designated with the same reference numerals increased by 100.

A plate-shaped footrest 110 is supported on a pivot bearing 112 by means of two parallel footrest carriers 148, the pivot bearing accommodating an arresting mechanism with two clamping-type locking mechanisms 116 each of which is held on one of the mounting plates 118. The mounting plates 18 have mounting lugs 150 for mounting them on a frame of a vehicle seat that has not been shown.

The inner rings of the locking mechanisms 16 and the ends of the footrest carriers 148 are keyed non-rotatably to the ends of a shaft 126 which is rotatably supported in and passes through the mounting plates 118. When the locking mechanisms are locked, the footrest 110 is arrested in its angular position relative to the mounting plates 118.

A release member 120 that has fingers engaging between the clamp rollers in the manner described above is in this case configured as a tube that surrounds the shaft 126. One end of a release lever 122 is attached to this tubular release member 120 in the center between the two locking mechanisms 116, and the release lever extends below the footrest 110 to the end of the footrest that is opposite to the pivot bearing, and at this opposite end, the release lever forms an actuating knob 152 that protects through a recess formed in the edge of the footrest 110, so that the actuating knob is readily accessible and can be actuated with a hand or a foot, for example, of a person sitting on the seat, in order to unlock the locking mechanism 16 and to tilt the footrest about the pivotal axis A.

What is claimed is:

1. An inclination-adjustable armrest comprising:
a pivot bearing formed at one end of the armrest, the pivot bearing defining a pivotal axis for the armrest,
a clamping-type locking mechanism arranged on the pivotal axis,
a release member that is rotatable about the pivotal axis for unlocking the clamping-type locking mechanism, and
an actuating mechanism for actuating the release member, the actuating mechanism having a release lever that is connected to the release member and is rotatable about the pivotal axis and which extends through an interior of the armrest to an end of the armrest opposite to the pivot bearing and exits the armrest at that opposite end.

2. The armrest according to claim 1, wherein the clamping-type locking mechanism is a clamp roll freewheel mechanism.

3. The armrest according to claim 2, wherein the clamping-type locking mechanism is a bidirectional clamp roll freewheel assembly.

4. The armrest according to claim 2, wherein the clamping-type locking mechanism is a unidirectional clamp roll freewheel assembly.

5. The armrest according to claim 2,
wherein the locking mechanism includes an inner ring and an outer ring,
further comprising:
an armrest carrier that determines the inclination of the armrest and
a shaft that is rotatable relative to the outer ring, and
wherein the inner ring of the locking mechanism and the armrest carrier are keyed onto the shaft that is rotatable relative to an outer ring of the locking mechanism when the locking mechanism is unlocked.

6. The armrest according to claim 5, wherein:
the clamp roll freewheel assembly includes clamp rollers, and
the release member is rotatable on the shaft within a limited angular range and has claws that engage between the clamp rollers of the clamp roll freewheel assembly.

7. The armrest according to claim 1, wherein the pivot bearing has two said clamping-type locking mechanisms arranged symmetrically to one another and being configured for being mounted in a center console of an automotive vehicle, with the release members of both locking mechanisms being connected to the release lever.

8. An inclination-adjustable footrest comprising:
a pivot bearing formed at one end of the footrest and defining a pivotal axis for the footrest,
a clamping-type locking mechanism arranged on the pivotal axis,
release member that is rotatable about the pivotal axis for unlocking the clamping-type locking mechanism, and
an actuating mechanism for actuating the release member, the actuating mechanism having a release lever that is connected to the release member and pivotable about the pivotal axis, the release lever extending to an end of the footrest opposite to the pivot bearing and having, at that opposite end of the footrest, an actuating knob that is positioned outside of the footrest.
